(19) United States
(12) Patent Application Publication
(10) Pub. No.: US 2019/0026718 A1
(43) Pub. Date: Jan. 24, 2019

(54) COMMODITY SCANNING APPARATUS

(71) Applicant: TOSHIBA TEC KABUSHIKI KAISHA, Tokyo (JP)

(72) Inventor: Hitoshi IIZAKA, Fuji Shizuoka (JP)

(21) Appl. No.: 16/037,463

(22) Filed: Jul. 17, 2018

(30) Foreign Application Priority Data
Jul. 19, 2017 (JP) 2017-139926

(51) Int. Cl. G06Q 20/20; G06K 9/62; G06K 7/14; G06K 7/10

(52) U.S. Cl. CPC G06Q 20/208; G06K 9/6215; G06K 7/10415; G06K 7/1413; G06K 7/1447

(57) ABSTRACT

A commodity scanning apparatus includes a touch screen, an imaging device, and a processor configured to calculate a similarity degree between a feature value of the imaged commodity and each of feature values predetermined for commodities, when a first greatest similarity degree is equal to or greater than a threshold and a difference between the first and a second greatest similarity degree does not fall within a predetermined range, recognize a commodity having the greatest degree as the imaged commodity, and when the degrees are equal to or greater than the threshold but the difference falls within the predetermined range, control the touch screen to display information about candidate commodities, and recognize a candidate commodity specified by an input as the imaged commodity, and notify a POS terminal of information about the recognized commodity. The similarity degree for another imaged commodity is calculated after a first period of time elapses.

### CROSS-REFERENCE TO RELATED APPLICATION

This application is based upon and claims the benefit of priority from Japanese Patent Application No. 2017-139926, filed Jul. 19, 2017, the entire contents of which are incorporated herein by reference.

### FIELD

Embodiments described herein relate generally to a commodity scanning apparatus.

### BACKGROUND

It is known that a commodity purchased at a supermarket is scanned and recognized by an imaging device of a checkout apparatus using an image recognition technique. Such an apparatus compares the feature value of the image obtained by the imaging device with a plurality of feature values predetermined for the commodities sold at the store, and when one of the commodities having a high similarity degree is detected, the apparatus determines that the commodity is recognized properly and automatically registers the commodity without any operation by a store clerk or a customer.

On the other hand, if the recognition fails, e.g., there are several candidates of commodities as a result of the comparisons, the conventional checkout apparatus suspends the automatic registration with the image recognition technique and instead displays a guidance screen that allows the store clerk to specify a commodity. Once an input has been made on the screen, the apparatus terminates the screen and immediately resumes the automatic recognition process for scanning and registering another commodity.

In such a checkout process, there is a case in which a hand of the store clerk or a part of an object other than commodities is inadvertently scanned before the next commodity is scanned, which results in failure of recognition and causes the guidance screen to show up. In this case, the store clerk needs to operate the operation screen to close the guidance and restart the commodity recognition process, leading to an increase in workload of the store clerk.

### DESCRIPTION OF THE DRAWINGS

FIG. 1 is a perspective view illustrating an example of a checkout system according to an embodiment;

FIG. 2 is a block diagram illustrating an example of hardware configurations of a POS terminal and a commodity scanning apparatus according to an embodiment;

FIG. 3 is a diagram schematically illustrating an example of a data structure of a PLU file according to an embodiment;

FIG. 4 is a block diagram illustrating an example of functions of the POS terminal and the commodity scanning apparatus according to an embodiment;

FIG. 5 is a diagram illustrating an example of a guidance screen according to an embodiment;

FIG. 6 is a flowchart for depicting an example of a procedure of a commodity scanning process executed by the commodity scanning apparatus according to an embodiment;

FIG. 7 is a diagram illustrating an example of a scanning start screen according to an embodiment;

FIG. 8 is a diagram illustrating an example of an execution screen of an object recognition according to an embodiment; and

FIG. 9 is a flowchart for depicting an example of a procedure of a guidance display process according to an embodiment.

### DETAILED DESCRIPTION

In accordance with an embodiment, a commodity scanning apparatus configured to communicate with a point-of-sale (POS) terminal includes a touch screen configured to display information and accept an input from an operator, an imaging device configured to image a commodity, and a processor. The processor is configured to calculate a similarity degree between a feature value of the imaged commodity and each of a plurality of feature values predetermined for a plurality of commodities, when a first greatest similarity degree calculated is equal to or greater than a threshold and a difference between the first greatest similarity degree and a second greatest similarity degree does not fall within a predetermined range, recognize one of the commodities having the first greatest similarity degree as the imaged commodity, and when the first and the second greatest similarity degree are equal to or greater than the threshold but the difference falls within the predetermined range, control the touch screen to display information about candidate commodities based on the first and the second greatest similarity degree, and recognize one of the candidate commodities specified by the input as the imaged commodity, and notify the POS terminal of information about the recognized commodity. The processor is configured to calculate the similarity degree for another imaged commodity after a first period of time elapses from the notification of the recognized commodity.

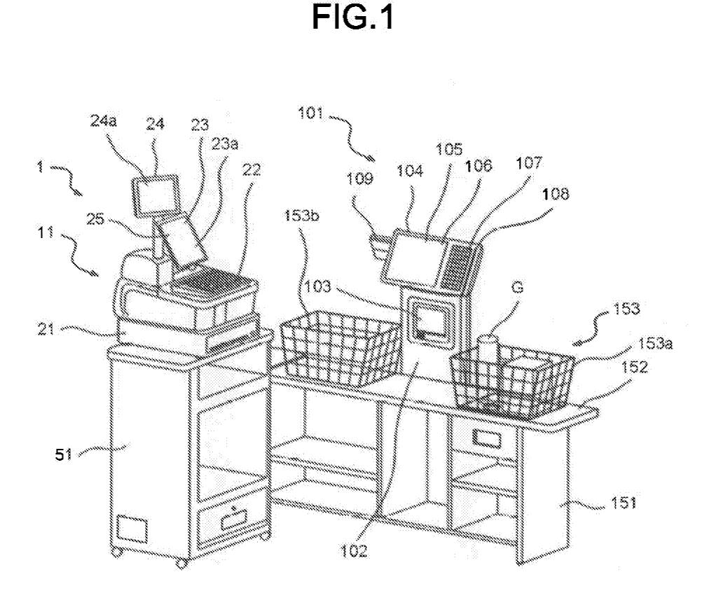

Hereinafter, a commodity scanning apparatus, a method carried out by the commodity scanning apparatus, and a non-transitory computer readable medium according to an embodiment are described with reference to the accompanying drawings. FIG. 1 is a perspective view illustrating an example of a checkout system 1 according to an embodiment. The checkout system 1 includes a POS terminal 11 and the commodity scanning apparatus 101. Such a checkout system 1 is introduced into, for example, a retail store such as a supermarket.

The POS terminal 11 is arranged on an upper surface of a drawer 21. The drawer 21 is placed on a checkout table 51. The drawer 21, which houses bills and coins therein, is opened or closed under the control of the POS terminal 11. The POS terminal 11 includes a keyboard 22, a display device 23, a display device for customer 24, and a touch panel 25.

The keyboard 22, which is arranged above the drawer 21, is operated by a store clerk (operator). The display device 23 displays information to the store clerk on a display surface 23a. The touch panel 25 is laminated on the display surface 23a to receive an operation by the store clerk. The display device for customer 24 displays information for a customer on a display surface 24a.

The commodity scanning apparatus 101 is placed on a counter table 151. An upper surface of the counter table 151 is a receiving surface 152. A shopping basket 153 which stores a commodity G therein is placed on the receiving surface 152. The shopping basket 153 includes a first shopping basket 153a brought by a customer and a second shopping basket 153b placed at a position facing the first shopping basket 153a across the commodity scanning apparatus 101.

The commodity scanning apparatus 101 is connected with the POS terminal 11 to be capable of transmitting and receiving data. The commodity scanning apparatus 101 includes a thin rectangular housing 102.

A scanning window 103 is arranged on the front surface of the housing 102. A display and operation section 104 is installed on the upper portion of the housing 102. A display device 106 such as a liquid crystal display device or the like on the surface of which the touch panel 105 is laminated is arranged in the display and operation section 104. A keyboard 107 is arranged at the right side of the display device 106. A card reading slot 108 is arranged at the right side of the keyboard 107. A display device for customer 109 for providing information to a customer is arranged on the back surface of the display and operation section 104 if viewed from the store clerk.

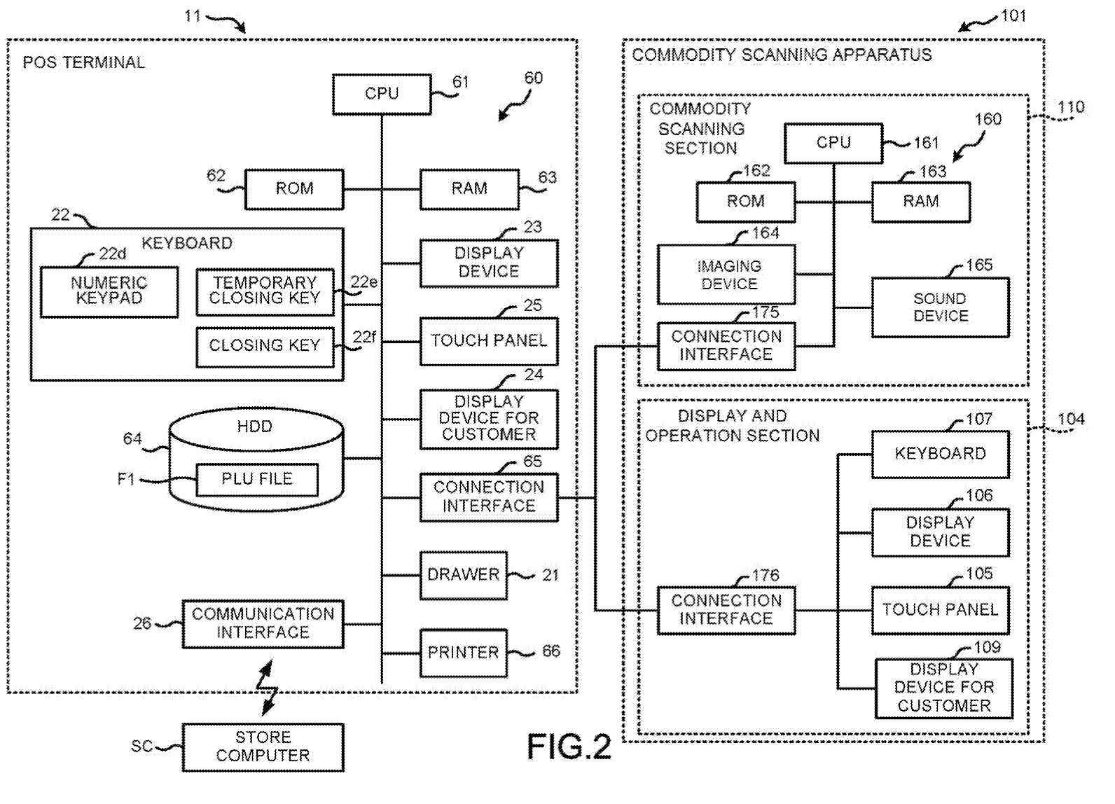

The commodities G in one transaction are stored in the first shopping basket 153a brought by the customer. The commodities G in the first shopping basket 153a are moved one by one to the second shopping basket 153b by the store clerk who operates the commodity scanning apparatus 101. During the movement, the commodity G is held over the scanning window 103 of the commodity scanning apparatus 101 by the store clerk. At this time, an imaging device 164 (refer to FIG. 2) arranged inside the scanning window 103 photographs the commodity G (article). In an embodiment, the commodity scanning apparatus 101 specifies a commodity G corresponding to the photographed article and outputs identification information (commodity ID, etc.) for identifying the specified commodity G to the POS terminal 11, i.e., scans the commodity.

FIG. 2 is a block diagram illustrating an example of the hardware structures of the POS terminal 11 and the commodity scanning apparatus 101 according to an embodiment. The POS terminal 11 includes a microcomputer 60 for executing an information process. The microcomputer 60 includes a Central Processing Unit (CPU) 61, a Read Only Memory (ROM) 62 and a Random Access Memory (RAM) 63. The microcomputer 60 further includes a clock circuit such as a Real Time Clock (RTC) circuit that measures the time.

The CPU 61 of the POS terminal 11 is connected to a communication interface 26, a Hard Disk Drive (HDD) 64, a connection interface 65, and a printer 66 in addition to respective sections (the drawer 21, the keyboard 22, the display device 23, the display device for customer 24 and the touch panel 25) shown in FIG. 1 via various input and output circuits (not shown). The keyboard 22 includes a numeric keypad 22d on the surface of which numerals and operators are displayed, a temporary closing key 22e, and a closing key 22f.

The HDD 64 stores data files such as a Price Look Up (PLU) file F1, various programs, and the like. The HDD 64 stores a sales master file (not shown) for registering a commodity read by the commodity scanning apparatus 101.

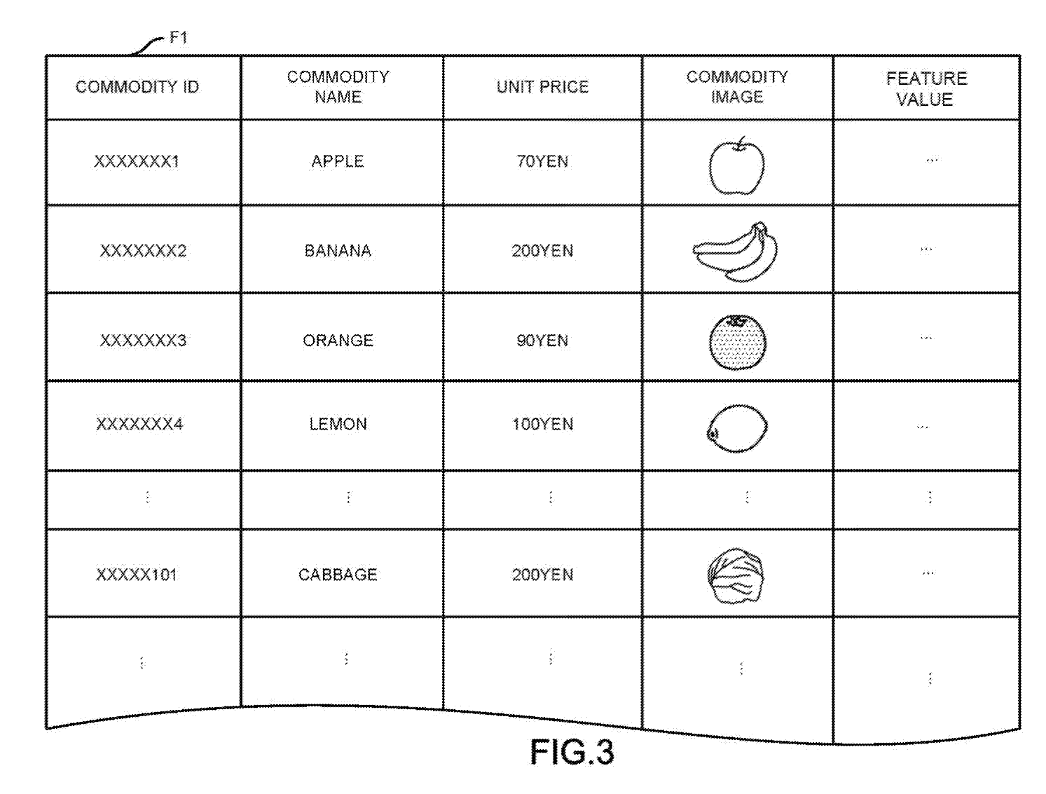

The PLU file F1 is a data file that associates the commodity G displayed and sold in the retail store with information relating to the sales registration of the commodity G. FIG. 3 is a diagram schematically illustrating an example of a data structure of the PLU file F1 according to an embodiment. As shown in FIG. 3, a commodity ID, information relating to the commodity G such as a commodity name and a unit price, and a commodity image obtained by photographing the commodity G are registered in an associated manner for each commodity G in the PLU file F1. In the PLU file F1, a feature value of the commodity G is associated with each commodity G, which is used in an object recognition described later. The commodity ID is identification information for identifying the commodity G, and is uniquely assigned to each commodity G.

The commodity image is obtained by previously photographing each commodity G sold in the retail store. The commodity image is displayed as an image representing a commodity candidate at the time of displaying the commodity candidate described later. Instead of the commodity image, an image or illustration for display may be registered in the PLU file F1 as well.

The feature value indicates characteristics of the commodity G, such as tint and pattern, unevenness, a shape, and the like of the surface of the commodity G. The feature value is used as a criterion for specifying the commodity G by a recognition section 1613 described later. The feature value is extracted previously from the captured image (for example, commodity image) of each commodity G.

In an embodiment, the feature value of each commodity G is registered in the PLU file F1 in advance. However, the recognition section 1613 described later may extract the feature value from each commodity image every time the object recognition is executed. In the PLU file F1, furthermore, the commodity ID associated with the barcode, the information about the commodity G such as the commodity name and the unit price, and the commodity image obtained by photographing the commodity G may be registered. The information about the commodity G associated with the barcode may be registered in another data file or the like. In the following, the commodity G registered in the PLU file F1 is referred to as a registered commodity.

Returning again to FIG. 2, the CPU 61 of the POS terminal 11 transmits and receives data to and from the commodity scanning apparatus 101 via the connection interface 65. The PLU file F1 stored in the HDD 64 can be read from the commodity scanning apparatus 101 via the connection interface 65.

The CPU 61 of the POS terminal 11 communicates with a store computer SC via the communication interface 26. The store computer SC is installed in a back office or the like of the retail store. A HDD (not shown) of the store computer SC stores the PLU file F1 delivered to the POS terminal 11, an inventory management file for managing an inventory state of each registered commodity registered in the PLU file F1, and the like.

The commodity scanning apparatus 101 includes a commodity scanning section 110 and the display and operation section 104. The commodity scanning section 110 includes a microcomputer 160, the imaging device 164, a sound device 165, and a connection interface 175. The microcomputer 160 includes a CPU 161, a ROM 162, a RAM 163, and a clock circuit (not shown) such as an RTC circuit.

The imaging device 164, which is a color CCD image sensor or a color CMOS image sensor, carries out an image capturing operation from the scanning window 103. For example, the imaging device 164 captures images of a moving object at 30 fps. The images (frame images, captured images) sequentially captured by the imaging device 164 at a predetermined frame rate are stored in the RAM 163. The imaging device 164 may also be referred to as a scanner. The scanning window 103 located outside the imaging device 164 may be referred to as a scanner in some cases.

The sound device 165 includes a sound circuit and a speaker for issuing a warning sound and the like. The connection interface 175 is connected to a connection interface 176 described later and the connection interface 65 of the POS terminal 11 to transmit and receive data.

The display and operation section 104 includes the touch panel 105, the display device 106, the keyboard 107, the display device for customer 109, and the connection interface 176. The connection interface 176 is connected to the connection interface 175 to transmit and receive data.

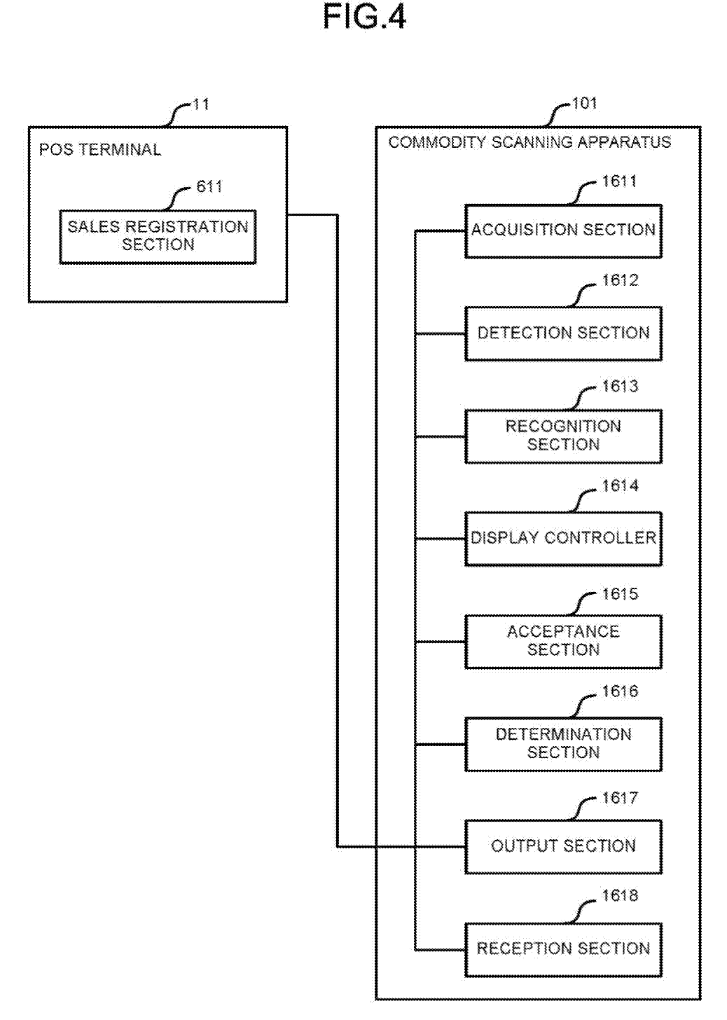

FIG. 4 is a block diagram illustrating an example of the functions of the POS terminal 11 and the commodity scanning apparatus 101 according to an embodiment. As shown in FIG. 4, the commodity scanning apparatus 101 includes an acquisition section 1611, a detection section 1612, a recognition section 1613, a display controller 1614, an acceptance section 1615, a determination section 1616, an output section 1617, and a reception section 1618.

The acquisition section 1611 outputs an image capturing start signal to the imaging device 164 to enable the imaging device 164 to start an image capturing operation. The acquisition section 1611 sequentially acquires images captured by the imaging device 164 from the RAM 163 after the image capturing operation is started. The images are acquired by the acquisition section 1611 in the order in which the images are stored in the RAM 163.

The detection section 1612 detects an article held over the scanning window 103 based on the images acquired by the acquisition section 1611. Specifically, the detection section 1612 detects contour lines of all or a part of articles contained in the image acquired by the acquisition section 1611 using a known pattern matching technology or the like. Next, the detection section 1612 compares the contour line extracted from a previous image (frame image) with the contour line extracted from the present frame image, and detects the difference to recognize an effective area in which the article is held over the scanning window 103. The method by which the detection section 1612 detects the article is not limited thereto.

In an embodiment, the article includes the commodity G and objects other than the commodity G. The objects other than the commodity G may be, for example, a part of the body of the store clerk (hand etc.), the shopping basket 153, and the like.

The recognition section 1613 specifies (determines) the commodity G corresponding to the article detected by the detection section 1612 by object recognition or scanning of the barcode. The commodity specified by the recognition section 1613 may also be referred to as a confirmed commodity.

Specifically, the recognition section 1613 determines whether a barcode is attached to the article detected by the detection section 1612 based on the image acquired by the acquisition section 1611. For example, if the recognition section 1613 recognizes that a barcode appears in the image acquired by the acquisition section 1611, the recognition section 1613 determines that the barcode is attached to the article detected by the detection section 1612. In this case, the recognition section 1613 reads the barcode to specify one commodity corresponding to the article from the commodities G registered in the PLU file F1. A well-known technology is used for recognition and reading of the barcode in the image by the recognition section 1613. The code symbol is not limited to a barcode, and may be a two-dimensional code or the like.

If the recognition section 1613 determines that no barcode is attached to the article detected by the detection section 1612, the recognition section 1613 performs the object recognition. The object recognition is a process of specifying the commodity corresponding to the article detected by the detection section 1612 through image recognition. Specifically, the recognition section 1613 extracts conditions of the surface (tint, pattern, unevenness and shape of the surface) of the article detected by the detection section 1612 as the feature value from the image acquired by the acquisition section 1611. Then, the recognition section 1613 compares the extracted feature value with the feature value of each commodity G registered in the PLU file F1 to calculate a similarity degree therebetween.

The similarity degree is a value indicating how much similar the both feature values are, which is obtained by comparing the feature value of the commodity G with the feature value which is the criterion of the commodity G registered in the PLU file F1. The similarity degree is not limited to that example, and it may be a value indicating a degree of coincidence with the feature value of each registered commodity registered in the PLU file F1, or a value indicating a degree of correlation between the feature value of commodity G and the feature value of each registered commodity registered in the PLU file F1. The recognition section 1613 calculates the similarity degree using, for example, a well-known technology such as generic object recognition.

The recognition section 1613 may calculate the similarity degree between the detected article and each registered commodity as an absolute evaluation or a relative evaluation. If the similarity degree is calculated as the absolute evaluation, the feature value of the detected article and the feature value of each registered commodity are compared one to one, and the similarity degree derived as a result of the comparison may be adopted as it is. If the similarity degree is calculated as the relative evaluation, the similarity degree may be calculated by setting the sum of the similarity degrees with respective registered commodities to 100%.

If there is a registered commodity with the similarity degree much higher than others among the registered commodities with the similarity degree equal to or higher than a threshold value, the recognition section 1613 specifies the registered commodity as the commodity G corresponding to the article detected by the detection section 1612. For example, the recognition section 1613 compares the highest similarity degree with the registered commodity with the second highest similarity degree with the registered commodity, and if the difference between the first and the second greatest similarity degree is 20% or more of the first similarity degree, specifies the registered commodity with the highest similarity degree as the commodity G corresponding to the detected article. The threshold value of the similarity degree is, for example, 75%, but the present invention is not limited thereto.

If the recognition section 1613 cannot specify one registered commodity as the commodity G, i.e., the difference between the calculated first and second greatest similarity degrees is below 20% of the first similarity degree but at least one of the degrees is equal to or higher than the threshold value, the recognition section 1613 extracts the registered commodity as a commodity candidate. The commodity candidate is displayed on a guidance screen described later. The recognition section 1613 sends the extracted commodity candidate to the display controller 1614 described later. If there is no registered commodity having a similarity degree equal to or higher than the threshold value, the recognition section 1613 sends information indicating that no commodity candidate exists to the display controller 1614. The information sent by the recognition section 1613 is displayed on the guidance screen described later by the display controller 1614.

The method of specifying the commodity G and extracting commodity in the object recognition is not limited thereto. The threshold value of the similarity degree which is used for the condition for specifying the commodity G and the threshold value of the similarity degree used for the condition for extracting the commodity candidate may be the same value or different values.

The recognition section 1613 stops the object recognition and reading of the barcode while the guidance screen is being displayed by the display controller 1614 described later, and restarts the object recognition and reading of the barcode if the display of the guidance screen is terminated.

Here, when a customer purchases a plurality of commodities G in one transaction, the plurality of commodities G is held over the scanning window 103 one by one by the store clerk and is photographed by the imaging device 164. In such a transaction, the recognition section 1613 does not perform the object recognition on a next commodity G until a first period of time elapses from the output of the previous commodity ID.

The output of the commodity ID means that the output section 1617 described later outputs the commodity ID of the commodity G corresponding to the article detected by the detection section 1612 to the POS terminal 11. The recognition section 1613 executes the object recognition after the first period of time elapses from the output of the commodity ID. The first period of time during which the recognition section 1613 does not perform the object recognition may also be referred to as an idle time, or a standby time. In an embodiment, the first period of time is 1 second, but the present invention is not limited thereto.

Generally, after the commodity ID is output, the store clerk moves the scanned commodity G to the second shopping basket 153b and then takes out the next commodity G from the first shopping basket 153a. Therefore, during a period until the store clerk holds the next commodity G over the scanning window 103 after the output of the commodity ID, the store clerk may inadvertently hold a part of his or her body close to the scanning window 103. In such a case, if the recognition section 1613 executes the object recognition on the part of the body (i.e., articles other than the commodity G), as the recognition section 1613 cannot specify the corresponding commodity G, the object recognition and reading of the barcode are stopped, and the guidance screen described later is displayed. In an embodiment, since the recognition section 1613 does not perform the object recognition until the first period of time elapses after the output of the previous commodity ID, it is possible to prevent the article other than the commodity G, such as a part of the store clerk's body, from being scanned as an object recognition target. Therefore, the recognition section 1613 according to an embodiment can decrease the chances of suspension of the object recognition, the reading of the barcode, and the display of unnecessary guidance screen.

If it is determined that the barcode is attached to the detected article, regardless of whether the first period of time elapses after the output of the previous commodity ID, the recognition section 1613 reads the barcode. For this reason, in an embodiment, the recognition section 1613 can read the barcode consecutively even during the standby time.

The display controller 1614 displays the guidance screen on the display device 106 if the recognition section 1613 cannot specify the commodity G corresponding to the detected article. The guidance screen is a screen on which the commodity candidates are shown in a selectable manner.

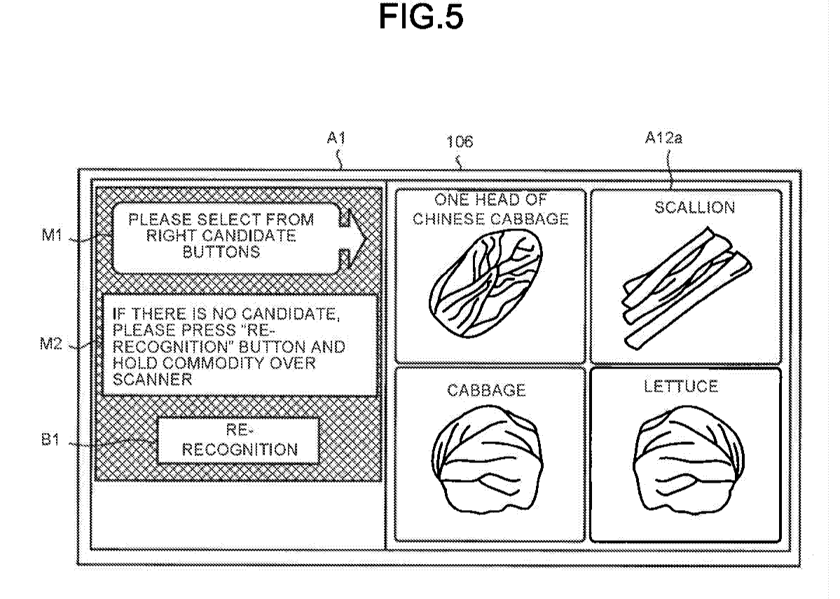

FIG. 5 is a diagram illustrating an example of a guidance screen A1 according to an embodiment. As shown in FIG. 5, the guidance screen A1 includes a selection button A12a, a re-recognition button B1, a message M1 for prompting selection of the commodity candidate, and a message M2 for prompting re-recognition of the commodity G (article). The selection button A12a is an image in which a commodity image of the registered commodity extracted as the commodity candidate is displayed as an option. The re-recognition button B1 allows an operator to request for starting over the object recognition or the reading of the barcode.

FIG. 5 shows an example in which four selection buttons A12a are displayed on the guidance screen A1, but the number of selection buttons A12a is not particularly limited. The display controller 1614 may dynamically increase or decrease the number of selection buttons A12a according to the number of commodity candidates. If no commodity candidate exists, the display controller 1614 may not display the selection button A12a or may display all the registered commodities in a selectable manner. In this case, the display controller 1614 may notify the store clerk by displaying a message such as “recognition error” or the like.

The display controller 1614 terminates the display of the guidance screen A1 if the acceptance section 1615 described later accepts that the selection button A12a or the re-recognition button B1 on the guidance screen A1 is operated. If the detection section 1612 detects the article (the article is framed in) after the article is no longer within an image capturing range of the imaging device 164 (the article is out of frame), the display controller 1614 terminates the display of the guidance screen A1.

The display controller 1614 terminates the display of the guidance screen A1 if a second period of time elapses since the determination section 1616 determines that the article no longer exists within the image capturing range of the imaging device 164. In an embodiment, the second period of time is 10 seconds, but the present invention is not limited thereto. The second period of time may also be referred to as duration of display. The display controller 1614 displays various screens on the display device 106 in order to show the operation procedures to the store clerk. Details of each screen are described later.

Returning again to FIG. 4, the acceptance section 1615 receives various input operations corresponding to the Graphical User Interface (GUI) components displayed on the display device 106 via the touch panel 105 or the keyboard 107. For example, the acceptance section 1615 receives an operation on any one of the selection buttons A12a corresponding to the commodity candidates which are displayed on the guidance screen A1. The acceptance section 1615 receives the selected commodity candidate as the commodity G corresponding to the article photographed by the imaging device 164. The acceptance section 1615 receives an operation for instructing restart of the object recognition or the reading of the barcode by operating the re-recognition button B1 displayed on the guidance screen A1.

While the guidance screen A1 is displayed, the determination section 1616 determines whether the detection section 1612 continuously detects the article from the image acquired by the acquisition section 1611, thereby determining whether the article exits within the image capturing range of the imaging device 164. More specifically, the determination section 1616 acquires from the detection section 1612 the result about the detection of the article from the images acquired in a time series, and if the article is continuously detected, the determination section 1616 determines that the article exists within the image capturing range of the imaging device 164. The determination section 1616 determines that the article no longer exists within the image capturing range of the imaging device 164 if the article is no longer detected from the images acquired in time series. The process of determining whether the article exists within the image capturing range may also be referred to as a pre-object recognition.

If the determination section 1616 determines that the article no longer exists within the image capturing range of the imaging device 164, a timer (not shown) is set to start clocking the second period of time (e.g., 10 seconds) during which the display controller 1614 continuously displays the guidance screen A1.

If the recognition section 1613 specifies the commodity G corresponding to the article, or if the acceptance section 1615 receives the selection of the commodity candidate, the output section 1617 outputs (transmits) the commodity ID of the commodity G to the POS terminal 11. The information output to the POS terminal 11 is information that can specify the commodity G, and may indicate a commodity name, a file name of the commodity image, a storage address in the PLU file F1, or the like. The output section 1617 may output a sales quantity separately input through the touch panel 105 or the keyboard 107 to the POS terminal 11 together with the commodity ID and the like.

The output section 1617 sets a timer (not shown) to start clocking the first period of time (e.g., 1 second) during which the recognition section 1613 does not perform the object recognition if the commodity ID of the commodity G is transmitted to the POS terminal 11. The means for clocking the time by the determination section 1616 and the output section 1617 are not limited to the timer.

The reception section 1618 receives a signal for notifying the start and end of scanning of the commodity G from the POS terminal 11.

As shown in FIG. 4, the POS terminal 11 includes a sales registration section 611. The sales registration section 611 performs the sales registration on the corresponding commodity G based on the commodity ID and the sales quantity output (notified) from the commodity scanning apparatus 101. Specifically, the sales registration section 611 refers to the PLU file F1 and records the notified commodity ID and the commodity name, the unit price, and the like associated with the commodity ID together with the sales quantity in a sales master file to perform the sales registration.

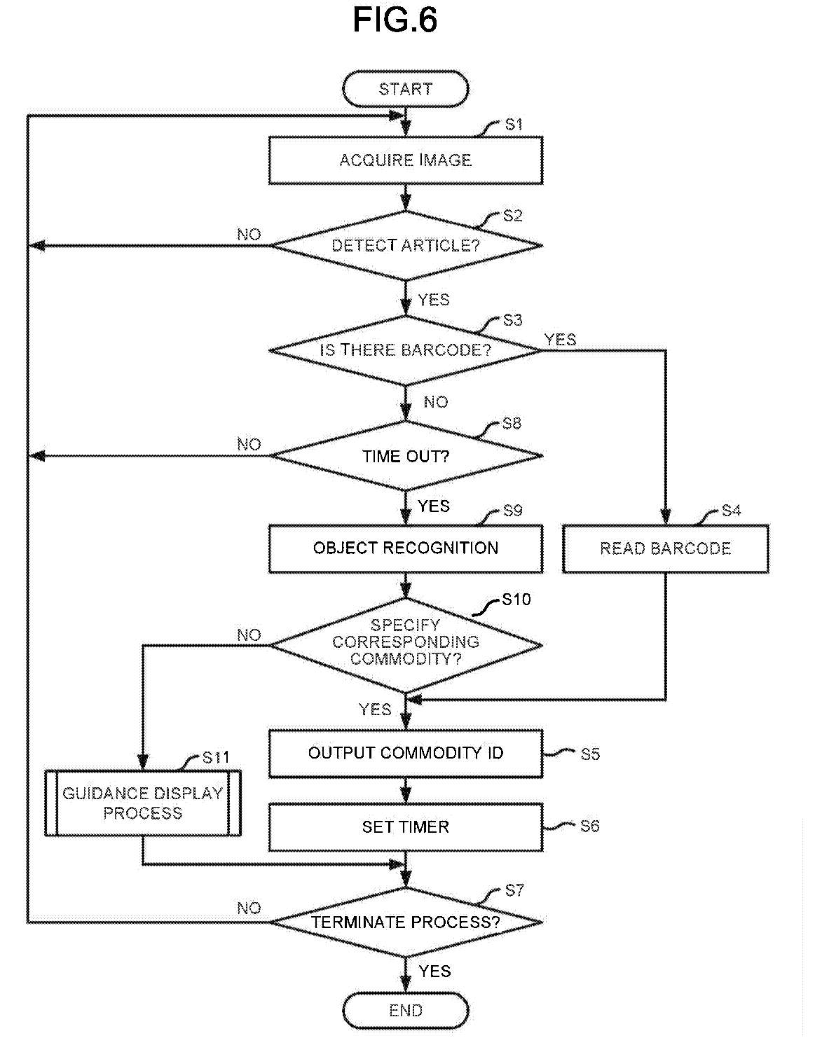

The operation of the checkout system 1 is described below. FIG. 6 is a flowchart for depicting an example of the procedure of the commodity scanning process executed by the commodity scanning apparatus 101 according to an embodiment. The process in this flowchart is started when the reception section 1618 receives notification of start scanning the commodity G from the POS terminal 11.

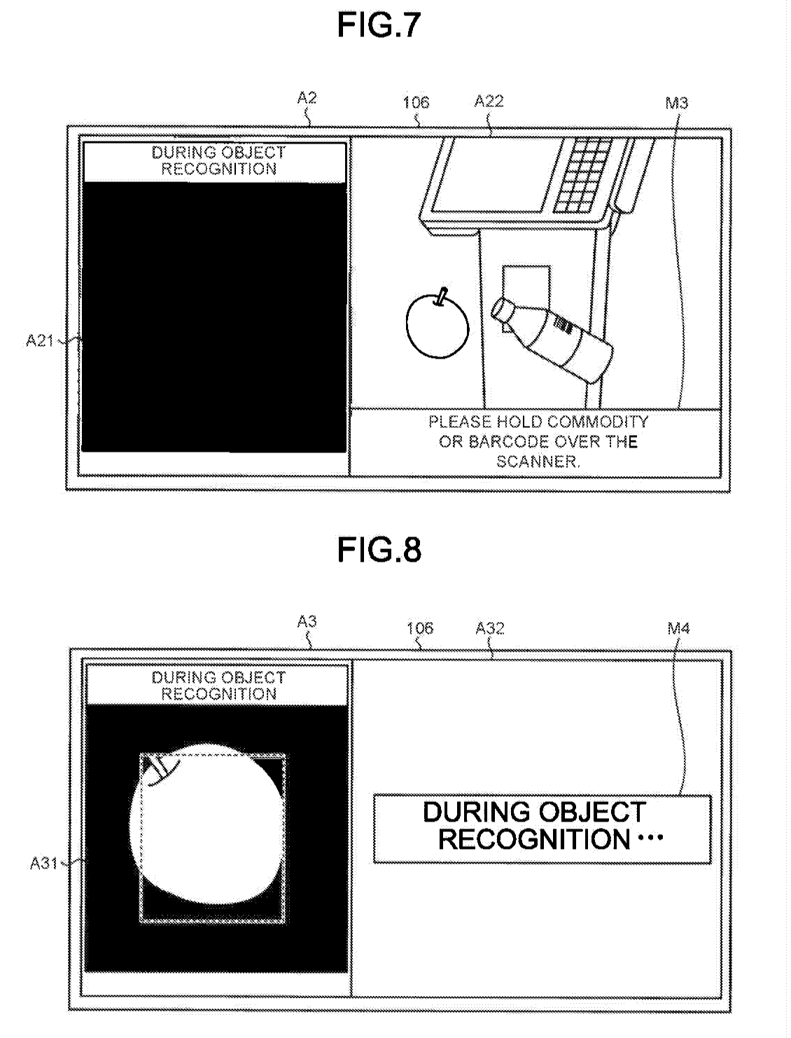

The acquisition section 1611 outputs an image capturing ON signal to the imaging device 164 to start the image capturing with the imaging device 164, and acquires an image captured by the imaging device 164 (Act S1). If the imaging device 164 starts the image capturing, the display controller 1614 displays a scanning start screen on the display device 106 to promote the store clerk to hold the article over the scanning window 103. FIG. 7 is a diagram illustrating an example of a scanning start screen A2 according to an embodiment. In the scanning start screen A2, an image acquired by the acquisition section 1611 is displayed in a first area A21, and an illustration and a message M3 for promoting the store clerk to hold the commodity G over the scanner (the scanning window 103) are displayed in a second area A22.

Then, the detection section 1612 detects the article from the image acquired by the acquisition section 1611. If the article is detected by the detection section 1612 (Yes in Act S2), the flow proceeds to the next process in Act S3. If the article is not detected (No in Act S2), the flow returns to the process in Act S1.

Next, the recognition section 1613 determines whether the barcode is attached to the article detected by the detection section 1612 based on the image acquired by the acquisition section 1611 (Act S3). If the recognition section 1613 determines that the barcode is attached to the article (Yes in Act S3), the recognition section 1613 reads the barcode to specify the commodity G corresponding to the article from the registered commodities registered in the PLU file F1 (Act S4).

The output section 1617 outputs the commodity ID of the commodity G specified by the recognition section 1613 to the POS terminal 11 (Act S5). At this time, the output section 1617 sets a timer and starts clocking the first period of time (Act S6).

Here, the acquisition section 1611 determines whether the reception section 1618 receives a signal for instructing the termination of the commodity scanning process from the POS terminal 11 (Act S7). If the signal for instructing the termination of the commodity scanning process is received (Yes in Act S7), the process in this flowchart is terminated. On the other hand, if the signal for instructing the termination of the commodity scanning process is not received (No in Act S7), the acquisition section 1611 returns to the process in Act S1 to acquire a new image.

If the recognition section 1613 determines that no barcode is attached to the article (No in Act S3), the recognition section 1613 determines whether the first period of time elapses since the output section 1617 outputs the commodity ID last time. Specifically, the recognition section 1613 determines whether the timer set by the output section 1617 in the process in Act S6 expires (Act S8). If the first output in the same transaction is not made, the recognition section 1613 does not make the determination in Act S8.

If the timer does not expire (No in Act S8), the recognition section 1613 does not perform the object recognition on the image. In this case, the flow returns to the process in Act S1, and the acquisition section 1611 acquires the next image.

If the timer expires (Yes in Act S8), the recognition section 1613 executes the object recognition (Act S9). Specifically, the recognition section 1613 extracts the feature value of the article detected in the detection section 1612 from the image acquired by the acquisition section 1611. Then, the recognition section 1613 compares the extracted feature value with the feature value of respective commodities G registered in the PLU file F1 to calculates the similarity degrees therebetween, respectively.

Then, the recognition section 1613 determines whether the commodity G corresponding to the article can be specified based on the calculated similarity degree (Act S10). Specifically, if there is one registered commodity with the similarity degree much higher than others among the registered commodities with the similarity degree equal to or higher than the threshold value, the recognition section 1613 specifies the registered commodity as the commodity G corresponding to the article detected by the detection section 1612 (Yes in Act S10).

While the recognition section 1613 executes the object recognition in Act S9, the display controller 1614 displays an execution screen of the object recognition on the display device 106. FIG. 8 is a diagram illustrating an example of an execution screen A3 of the object recognition according to an embodiment. On the execution screen A3, the image acquired by the acquisition section 1611 is displayed in a first area A31, and a message M4 indicating that the object recognition is being executed is displayed in a second area A32.

If the recognition section 1613 specifies the commodity G corresponding to the article (Yes in Act S10), the output section 1617 performs the processes in Act S5 and Act S6. In this case, the acquisition section 1611 performs the process in Act S7.

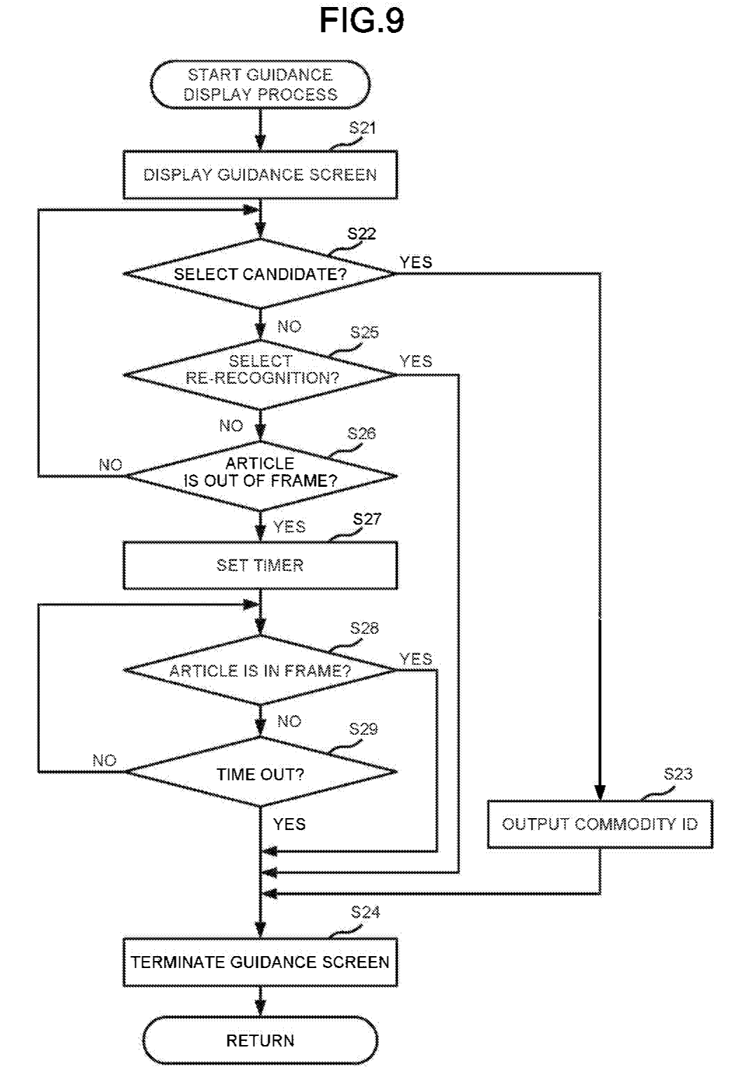

On the other hand, if the commodity G corresponding to the article cannot be specified (No in Act S10), the recognition section 1613 extracts these registered commodities as the commodity candidates if there are registered commodities with the similarity degree equal to or higher than the threshold value, and transmits the commodity candidates to the display controller 1614. If there is no such registered commodity whose similarity degree is equal to or higher than the threshold value, the recognition section 1613 sends a message indicating that there is no commodity candidate to the display controller 1614. If the recognition section 1613 cannot specify the commodity G corresponding to the article, the display controller 1614 executes a guidance display process (Act S11). After the guidance display process, the process in Act S7 is executed. FIG. 9 is a flowchart for depicting an example of the procedure of the guidance display process according to an embodiment.

The display controller 1614 displays the guidance screen A1 on the display device 106 (Act S21). If the acceptance section 1615 receives an operation for selecting any one of the commodity candidates from the selection buttons A12a on the guidance screen A1 (Yes in Act S22) while displaying the guidance screen A1, the acceptance section 1615 receives the selected commodity candidate as the commodity G corresponding to the article captured by the imaging device 164.

If the acceptance section 1615 receives the selection of the commodity candidate, the output section 1617 outputs the commodity ID of the selected commodity G to the POS terminal 11 (Act S23). In this case, the output section 1617 sets the timer to starts clocking the first period of time in the same manner as the process in Act S6 in FIG. 6.

If any one of the commodity candidates is selected as the commodity G corresponding to the article and the commodity ID of the corresponding commodity G is output to the POS terminal (Yes in Act S22, Act S23), the display controller 1614 terminates the display of the guidance screen A1 (Act S24).

If the acceptance section 1615 receives a message indicating the re-recognition button B1 displayed on the guidance screen A1 is operated (re-recognition is selected) (No in Act S22, Yes in Act S25), the display controller 1614 terminates the display of the guidance screen A1 (Act S24). If the display controller 1614 terminates the display of the guidance screen A1, the process in this flowchart is terminated, and the flow returns to the process in the flowchart shown in FIG. 6.

On the other hand, if neither the selection button A12a nor the re-recognition button B1 on the guidance screen A1 is operated (No in Act S22, No in Act S25), the determination section 1616 determines whether the article exits within the image capturing range of the imaging device 164, i.e., whether the article is out of frame (Act S26). If the determination section 1616 determines that the article no longer exists within the image capturing range of the imaging device 164, i.e., the article is out of frame (Yes in Act S26), a timer is set to start clocking the second period of time during which the display controller 1614 continuously displays the guidance screen A1 (Act S27).

If the article exists within the image capturing range of the imaging device 164, i.e., the article is not out of frame (No in Act S26), the determination section 1616 continues to determine whether the article exits within the image capturing range of the imaging device 164. While the determination section 1616 continues the determination process, the acceptance section 1615 repeats the processes in Act S22 and S25 in the same way as described above.

If the detection section 1612 detects the article (the article is in the frame) (Yes in Act S28) after the article is out of frame, the display controller 1614 terminates the display of the guidance screen A1 (Act S24). The article that is out of frame and the article that is in the frame thereafter may be different articles. For example, if the hand of the store clerk is detected in Act S2, and after the hand of the store clerk moves out of frame from the image capturing range in Act S26, the commodity G exists within the image capturing range in Act S28, the display controller 1614 terminates the display of the guidance screen A1.

If no article is in the frame after the article is out of frame (No in Act S28), the display controller 1614 determines whether the second period of time elapses (whether the timer set in Act S27 expires) (Act S29).

If the timer set in ACT S27 does not expire yet (No in Act S29), the display controller 1614 continues to display the guidance screen A1. The processes in ACT S28 and S29 are repeated in the same way as described above until the timer expires. Even after the article is out of frame, while the guidance screen A1 is continuously displayed, the acceptance section 1615 can receive the selection of the commodity candidate in Act S22 and the operation on the re-recognition button B1 in Act S25.

If the timer set in Act S27 expires (Yes in Act S29), the display controller 1614 terminates the display of the guidance screen A1 (Act S24) and returns to the process in the flowchart shown in FIG. 6.

As described above, as the commodity scanning apparatus 101 of an embodiment executes the object recognition after the first period of time elapses since the output of the commodity ID, it is possible to prevent the article other than the commodity G from being the object recognition target, and accordingly, it is possible to prevent the process of recognizing the commodity G from stopping and prevent the unnecessary guidance screen A1 from being displayed. Therefore, according to the commodity scanning apparatus 101 of the present embodiment, it is possible to reduce the workload of the store clerk which is caused by the restart of the process of recognizing the commodity G.

If it is determined that the barcode is attached to the detected article, the commodity reading apparatus 101 of an embodiment reads the barcode regardless of whether the first period of time elapses from the output of the previous commodity ID. Therefore, according to the commodity scanning apparatus 101 of an embodiment, it is possible to continuously read the barcode without arranging waiting time, and it is possible to suppress a decrease in the work efficiency of the store clerk.

The commodity scanning apparatus 101 of an embodiment terminates the display of the guidance screen A1 and restarts the object recognition or reading of the barcode if the article is detected after it is determined that the article no longer exists within the image capturing range while the guidance screen A1 is displayed. Therefore, according to the commodity scanning apparatus 101 of an embodiment, as the display of the guidance screen A1 is terminated and the object recognition is restarted even if there is no operation on the guidance screen A1 by the store clerk, it is possible to reduce the workload of the store clerk which is caused by the restart of the process of recognizing the commodity G.

Since the commodity scanning apparatus 101 of an embodiment terminates the display of the guidance screen A1 if the second period of time elapses after it is determined that the article no longer exists within the image capturing range, it is possible to further reduce the workload of the store clerk.

The configurations of the checkout system 1, the POS terminal 11 and the commodity scanning apparatus 101 of an embodiment are merely an example, and the present invention is not limited thereto. In an embodiment, the user is a store clerk (operator), but the present invention is not limited thereto. For example, the commodity scanning apparatus 101 may be applied to a self-checkout apparatus (a self-checkout POS), and in this case, the user is a customer.

In the commodity scanning apparatus 101 of an embodiment, a timing at which the clocking of the first period of time is started during which the object recognition is not executed by the recognition section 1613 is based on the output of the previous commodity ID; however, the previous sales registration by the sales registration section 611 may also be used as a reference.

The display contents and the screen configurations of the guidance screen A1, the scanning start screen A2, and the execution screen A3 shown in FIG. 5, FIG. 7, and FIG. 8 are merely examples, and the present invention is not limited thereto. The display controller 1614 may display various screens on the display device 106 in addition to those above-described screens.

Only a part of functions of respective sections of the commodity scanning apparatus 101 of an embodiment described above may be adopted. For example, the commodity scanning apparatus 101 may execute one or two operations among an operation of not executing the object recognition by the recognition section 1613 until the first period of time elapses from the output of the previous commodity ID, an operation of terminating the display of the guidance screen A1 by the display controller 1614 if the detection section 1612 detects an article after the article no longer exists within the image capturing range of the imaging device 164, and an operation of terminating the display of the guidance screen A1 by the display controller 1614 if the second period of time elapses after the determination section 1616 determines that the article no longer exists within the image capturing range of the imaging device 164.

The programs such as the commodity scanning program executed by the commodity scanning apparatus 101 and the POS terminal 11 according to an embodiment may be incorporated into a ROM or the like to be provided. The programs may be recorded in a computer-readable recording medium such as a CD-ROM, a FD (Flexible Disk), a CD-R, a DVD (Digital Versatile Disk) and the like in the form of installable or executable file to be provided. Furthermore, the programs executed by the commodity scanning apparatus 101 and the POS terminal 11 according to an embodiment may be stored in a computer connected with a network such as the Internet and downloaded via the network to be supplied. The programs executed by the commodity scanning apparatus 101 and the POS terminal 11 according to an embodiment may be provided or distributed via the network such as the Internet.

The commodity scanning program executed by the commodity scanning apparatus 101 of an embodiment has a module configuration including the above-described sections (the acquisition section, the detection section, the recognition section, the display controller, the acceptance section, the determination section, the output section, and the reception section). The CPU (processor) reads out the commodity scanning program from the storage medium to load the respective sections on a main storage device. Thus, the acquisition section, the detection section, the recognition section, the display controller, the acceptance section, the determination section, the output section, and the reception section are generated on the main storage device. The program executed by the POS terminal 11 of an embodiment has a module configuration including the sales registration section described above. The CPU reads out the program from the storage medium to load the sales registration section on the main storage device. As a result, the sales registration section is generated on the main storage device.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A commodity scanning apparatus configured to communicate with a point-of-sale (POS) terminal, comprising:
a touch screen configured to display information and accept an input from an operator;
an imaging device configured to image a commodity; and
a processor configured to:
calculate a similarity degree between a feature value of the imaged commodity and each of a plurality of feature values predetermined for a plurality of commodities,
when a first greatest similarity degree calculated is equal to or greater than a threshold and a difference between the first greatest similarity degree and a second greatest similarity degree does not fall within a predetermined range, recognize one of the commodities having the first greatest similarity degree as the imaged commodity, and
when the first and the second greatest similarity degree are equal to or greater than the threshold and the difference falls within the predetermined range, control the touch screen to display information about candidate commodities based on the first and the second greatest similarity degree, and recognize one of the candidate commodities specified by the input as the imaged commodity, and
notify the POS terminal of information about the recognized commodity, wherein
the processor is configured to calculate the similarity degree for another imaged commodity after a first period of time elapses from the notification of the recognized commodity.

2. The commodity scanning apparatus according to claim 1, wherein
the processor is configured to read a barcode from the image and recognize one of the commodities associated with the barcode.

3. The commodity scanning apparatus according to claim 2, wherein
the processor is configured to recognize the other imaged commodity with the barcode regardless of whether the first period of time elapses.

4. The commodity scanning apparatus according to claim 3, wherein
the processor is configured to notify the POS terminal of information about the commodity recognized with the barcode, and calculate the similarity degree for yet another imaged commodity after the first period of time elapses.

5. The commodity scanning apparatus according to claim 1, wherein
the processor is configured to monitor a presence of the commodity being imaged, and control the touch screen to display a button for starting over the calculation.

6. The commodity scanning apparatus according to claim 5, wherein
when the processor detects absence of the commodity for a predetermined period, the processor is configured to control the touch screen to stop displaying the information about candidate commodities.

7. The commodity scanning apparatus according to claim 1, wherein
the candidate commodities are visually displayed on the touch screen.

8. The commodity scanning apparatus according to claim 1, wherein
the processor is configured to control the touch screen to display a message that encourages the operator to scan a commodity with the imaging device.

9. The commodity scanning apparatus according to claim 8, wherein
when the similarity degree is calculated, the processor is configured to control the touch screen to display a message that indicates that the commodity is being recognized.

10. The commodity scanning apparatus according to claim 1, wherein
the first period of time is one second.

11. A method carried out by a commodity scanning apparatus configured to communicate with a point-of-sale (POS) terminal, the method comprising:
imaging a commodity;
calculating a similarity degree between a feature value of the imaged commodity and each of a plurality of feature values predetermined for a plurality of commodities;
when a first greatest similarity degree calculated is equal to or greater than a threshold and a difference between the first greatest similarity degree and a second greatest similarity degree does not fall within a predetermined range, recognizing one of the commodities having the first greatest similarity degree as the imaged commodity; and
when the first and the second greatest similarity degree are equal to or greater than the threshold but the difference falls within the predetermined range,
displaying, on a touch screen, information about candidate commodities based on the first and the second greatest similarity degree, and
recognizing one of the commodities specified by an input on the touch screen as the imaged commodity; and
notifying the POS terminal of information about the recognized commodity, wherein
the similarity degree for another imaged commodity is calculated after a first period of time elapses from the notification of the recognized commodity.

12. The method according to claim 11, further comprising:
detecting a barcode from the image and recognizing one of the commodities associated with the barcode.

13. The method according to claim 12, wherein
the other imaged commodity is recognized with the barcode regardless of whether the first period of time elapses.

14. The method according to claim 13, further comprising:
notifying the POS terminal of information about the commodity recognized with the barcode; and
calculating the similarity degree for yet another imaged commodity after the first period of time elapses.

15. The method according to claim 11, further comprising:
monitoring a presence of the commodity being imaged; and
displaying on the touch screen a button for starting over the calculation.

16. The method according to claim 15, further comprising:
when absence of the commodity is detected for a predetermined period, stopping displaying on the touch screen the information about candidate commodities.

17. The method according to claim 11, wherein
the candidate commodities are visually displayed on the touch screen.

18. The method according to claim 11, further comprising:
displaying on the touch screen a message that encourages an operator to scan a commodity.

19. The method according to claim 18, further comprising:
when the similarity degree is calculated, displaying on the touch screen a message that indicates that the commodity is being recognized.

20. A non-transitory computer readable medium storing a program causing a computer to execute a scanning process comprising the steps of:
imaging a commodity;
calculating a similarity degree between a feature value of the imaged commodity and each of a plurality of feature values predetermined for a plurality of commodities;
when a first greatest similarity degree calculated is equal to or greater than a threshold and a difference between the first greatest similarity degree and a second greatest similarity degree does not fall within a predetermined range, recognizing one of the commodities having the first greatest similarity degree as the imaged commodity; and
when the first and the second greatest similarity degree are equal to or greater than the threshold but the difference falls within the predetermined range,
displaying, on a touch screen, information about candidate commodities based on the first and the second greatest similarity degree, and
recognizing one of the commodities specified by an input on the touch screen as the imaged commodity; and
notifying the POS terminal of information about the recognized commodity, wherein
the similarity degree for another commodity is calculated after a first period of time elapses from the notification of the recognized commodity.
